(19) United States
(12) Patent Application Publication
(10) Pub. No.: US 2010/0188006 A1
(43) Pub. Date: Jul. 29, 2010

(54) Dimming alternating current light emitting diodes

(75) Inventor: Garrett Joseph Young, Sully, IA (US)

Correspondence Address: Garrett Young, PO Box 443, Sully, IA, 50251, US

(73) Assignee: Garrett Joseph Young, Sully, IA (US)

(21) Appl. No.: 12/657,825

(22) Filed: Jan. 27, 2010

Related U.S. Application Data
(60) Provisional application No. 61/206,123, filed on Jan. 28, 2009.

(51) Int. Cl. H05B 37/02

(52) U.S. Cl. 315/224

(57) ABSTRACT

The disclosed invention directs the current path of the light source through a signal rectifier and series switch, which is controlled by the pulse width modulation (PWM) generator based on the input intensity level. The direct current series switch (i.e. MOSFET) does not require a minimum current level, or “holding current”, to respond correctly to the control signal. The modulated control signal continues over the entire cycle period, which ensures accurate duty cycle control regardless of the minimum forward voltage bias, or “turn on voltage”, of the light source. In addition, accurate duty cycle control allows the possibility of non-linear dimming curves to compensate for human factors or characteristics of the light source. The high frequency (i.e. >2 kHz) of the modulation results in the users perception of consistent intensity and smooth transitions. The disclosed invention addresses the principle issues associated with dimming AC LED technology, while maintaining compatibility with traditional incandescent sources, by providing accurate duty cycle control independent of I-V characteristics of the light source and not requiring a “holding current”. The disclosed invention can adjust the intensity of any LED device that reacts to a significant portion of the ON and OFF time periods created by the modulation of the input power.

### CROSS REFERENCE TO RELATED APPLICATIONS

This application claims the benefit of U.S. Provisional Application No. 61/206,123, filed on 28 Jan., 2009, under 35 U.S.C. §119(e), which is hereby incorporated by reference.

### TECHNICAL FIELD

This application relates generally to LED lighting, and more particularly to LED lighting for applications requiring dimming and/or color mixing capabilities.

### BACKGROUND

Conventional silicon controlled rectifier (SCR) dimmers designed for incandescent lamps generally employ a technique that removes a single, continuous section of the input alternating current (AC) waveform during both the positive and negative portions of the cycle, proportional to the desired intensity (FIGS. 2a and 2b). The operation, design, advantages, and disadvantages of SCR dimmers and incandescent lamps are well known. The introduction of light emitting diode (LED) technology, and more specifically LED devices capable of receiving power directly from an AC source without the need for intermediate power conversion to direct current (DC) or those that only require basic signal rectification, present new challenges for dimmer technology that are not adequately addressed by conventional means.

AC LEDs, such as the Acriche manufactured by Seoul Semiconductor of Seoul, South Korea, use a semiconductor chip composed of an LED array electrically wired at the semiconductor or package level in series, in at least two anti-parallel strings, or as a rectification circuit. Although AC LEDs offer the advantages of simplicity, cost-effectiveness, and negligible power conversion losses, they react adversely to SCR dimmers. The typical AC LED draws less than fifty milliamps, which is below the minimum current level, known as the “holding current,” required for most SCRs to maintain an “on” state. In addition, the non-linear current/voltage (I-V) response of LEDs disconnects the direct proportionality of input waveform to output luminous intensity. Both of these characteristics cause SCR dimmers to be overwhelmingly unresponsive to user input and connected LEDs to illuminate intermittently throughout operation.

### SUMMARY

The disclosed invention directs the current path of the light source through a signal rectifier and series switch, which is controlled by the pulse width modulation (PWM) generator based on the input intensity level. The direct current series switch (i.e. MOSFET) does not require a minimum current level, or “holding current”, to respond correctly to the control signal. The modulated control signal continues over the entire cycle period, which ensures accurate duty cycle control regardless of the minimum forward voltage bias, or “turn on voltage”, of the light source. In addition, accurate duty cycle control allows the possibility of non-linear dimming curves to compensate for human factors or characteristics of the light source. The high frequency (i.e. >2 kHz) of the modulation results in the users perception of consistent intensity and smooth transitions. The disclosed invention addresses the principle issues associated with dimming AC LED technology, while maintaining compatibility with traditional incandescent sources, by providing accurate duty cycle control independent of I-V characteristics of the light source and not requiring a “holding current”. The disclosed invention can adjust the intensity of any LED device that reacts to a significant portion of the ON and OFF time periods created by the modulation of the input power.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their equivalents.

### BRIEF DESCRIPTION OF THE DRAWINGS

FIG. 1 illustrates the flow diagram of the AC LED dimmer.

FIG. 2a-2d compares the waveforms of a SCR dimmer versus the AC LED dimmer.

FIG. 3 depicts one possible circuit design for the AC LED dimmer.

FIG. 4 shows a flow diagram of a multi-channel arrangement of the AC LED dimmer.

### DETAILED DESCRIPTION

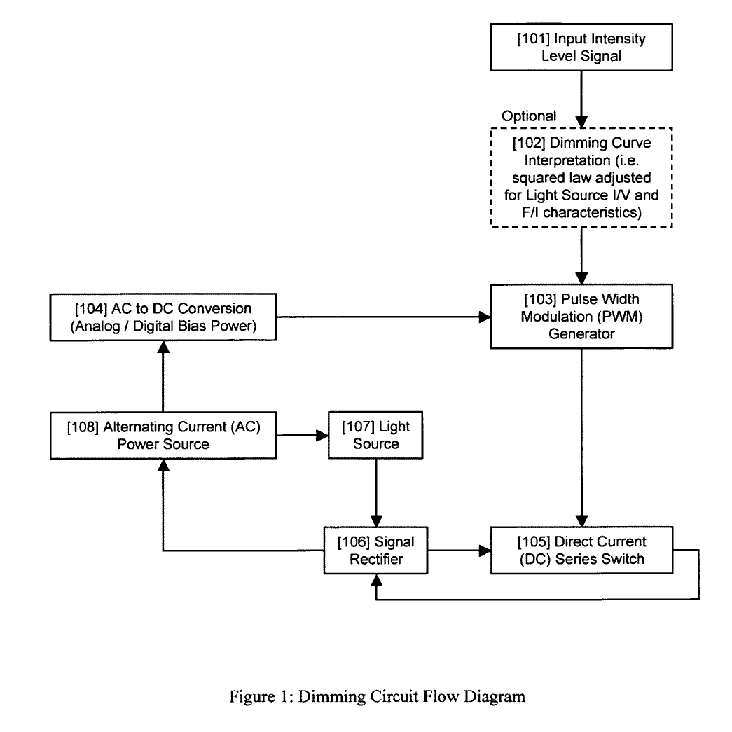

In FIG. 1, the user inputs an intensity level signal [101] by adjusting a potentiometer, multi-position switch, or capacitive touch element. Optionally, the intensity level signal is modified [102] using one of several methods, such as a potentiometer with a logarithmic response, an operational amplifier with a logarithmic or programmable gain, or a microcontroller with analog to digital converter in a mathematical translation or lookup table. The objective of translating the input intensity signal level to a non-linear response curve is to match the characteristics of the human eye and/or the LED device. A digital or analog pulse width modulation (PWM) generator [103] that is powered by the AC to DC Conversion [104] circuit interprets the modified or unmodified intensity level signal into a duty cycle that varies from zero to one hundred percent. The high frequency (i.e. >2 kHz) of the modulation results in the user's perception of consistent intensity and smooth transitions. The variable duty cycle signal is then fed to the Direct Current switch [105], which can be a device such as a MOSFET or an IGBT. The Direct Current switch [105] is in series with the AC signal rectifier [106] and effectively disconnects or connects the current path through the light source [107]. The alternating current [108] power provided to the light source [107] is therefore temporally modulated by the input intensity level signal [101].

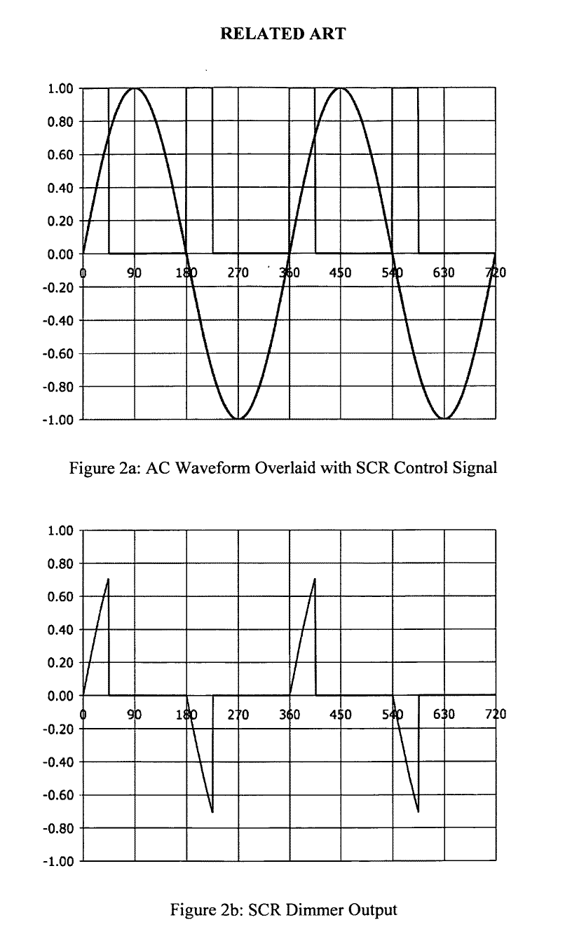

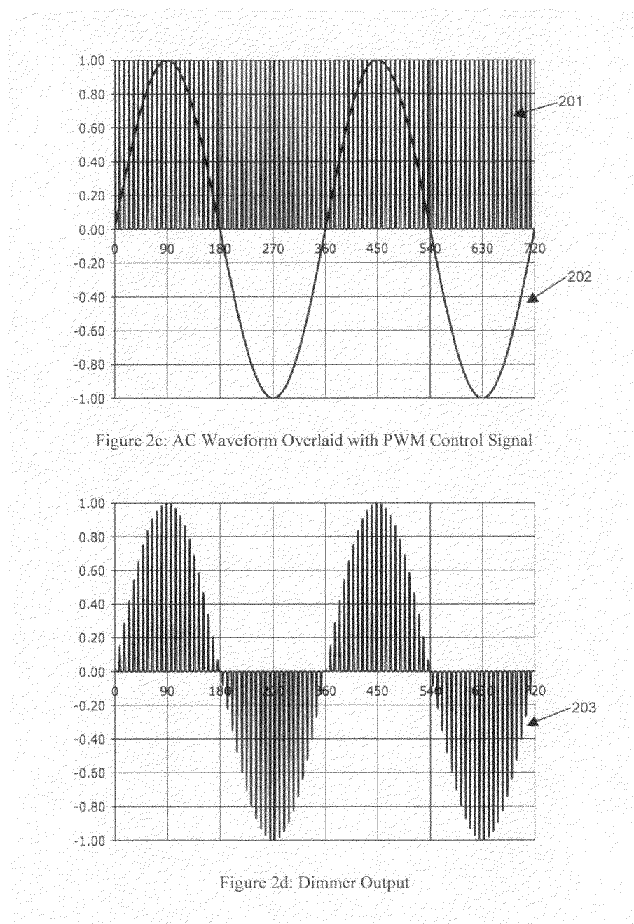

FIG. 2c shows the sinusoidal AC waveform overlaid with the pulse-width modulated control signal. FIG. 2d shows the dimmer output, which is the result through the light source.

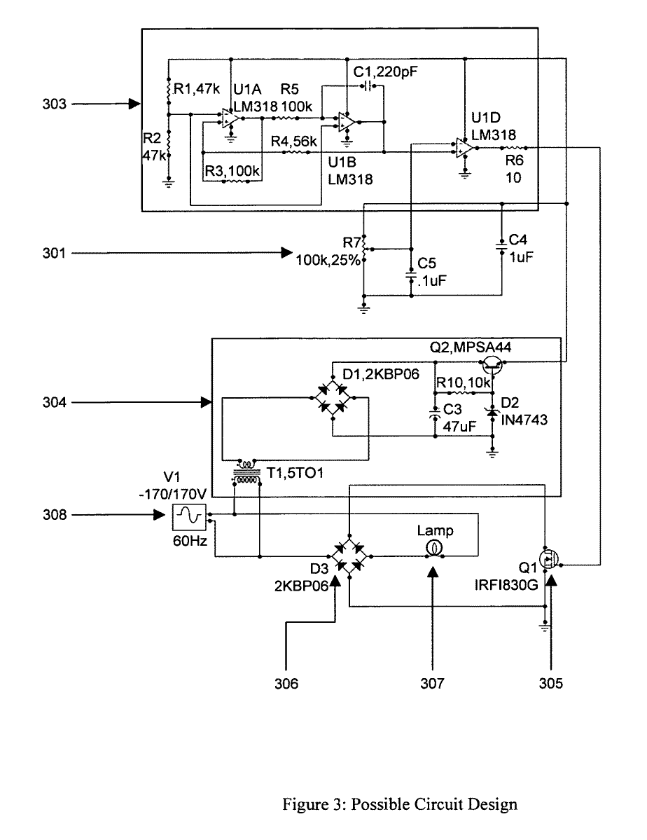

FIG. 3 details an example of a circuit design for a dimming circuit. An AC/DC converter [304] provides power for the control circuitry [301 & 303]. The analog PWM generator [303] uses an operational amplifier (op-amp) to generate a square wave of a desired frequency, which is integrated by a second op-amp resulting in a triangle wave that is compared with the potentiometer wiper voltage using a third op-amp. The voltage comparison produces a variable pulse width signal depending on the user's manipulation of the potentiometer. The PWM signal is then fed to an N-channel MOSFET [305], which is a DC-current switch in series with full bridge rectifier [306]. MOSFET [305] disconnects or connects the current path through LED light source [307]. The AC power [308] provided to LED source [307] is temporally modulated by the user input [301].

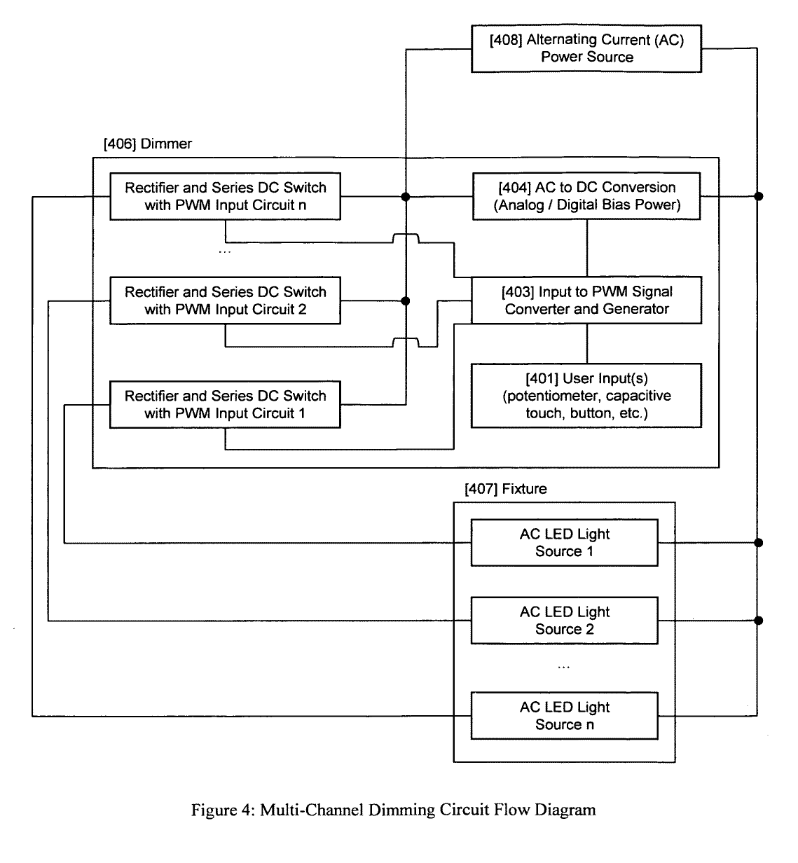

FIG. 4 illustrates a flow diagram for a multi-channel dimming circuit, which combines the control of two or more light source groups embedded in one or more fixtures. The user input [401] is sent to the PWM signal converter and generator [403], which is powered by an AC to DC converter [404]. Each of two or more light source groups [407] has an individual rectification and series DC switch circuit [406], which connects or disconnects the current path through each light source group [407]. Therefore the AC power provided by power source [408] to light source groups [407] is individually temporally modulated by user input [401].

A specialized fixture connector would be required for a multi-channel circuit, with a pin for the input voltage and a pin for the return voltage of each light source group [407]. In a three channel system, an example of an appropriate connector would be the 26725-405 from Leviton of Little Neck, N.Y., USA.

The invention has several inherent advantages: The direct current series switch does not require a minimum current level, or “holding current”, to respond correctly to the control signal, enabling the system to be used with solid-state light sources (LEDs). The modulated control signal continues over the entire cycle period, which ensures accurate duty cycle control regardless of the minimum forward voltage bias, or “turn on voltage”, of the light source. In addition, accurate duty cycle control allows the possibility of non-linear dimming curves to compensate for human factors or characteristics of the light source. Finally, the high frequency (i.e. >2 kHz) of the modulation results in the users perception of consistent intensity and smooth transitions.

The potential applications for the invention are many and varied. A system using a single channel could be used in any commercial or residential lighting application requiring the ability to dim LEDs. Systems utilizing multiple channels have the additional ability to be used in color-mixing applications (allowing the user to create custom colors) or to customize color temperatures, such as cool and warm whites. Both single and multi-channel light source systems could be used to provide variable intensity and/or color in such lighting applications as restaurants, theme parks, museums, hotels, and retail.

What is claimed is:

1. A system, comprising:
at least one rectification component,
at least one series DC current switch,
at least one duty cycle modulation unit,
at least one means for a user to input desired intensity level,
at least one power supply for the control circuitry,
at least one LED light source attached directly or through a rectifier component to AC line voltage, and
at least one passive current limiting element in series with the LED light source.

2. The system of claim 1, further comprising a module that adjusts the user input to compensate for characteristics of the human eye and/or light source.

3. The system of claim 1, further comprising a microcontroller that generates at least one duty cycle modulation signal based on user input.

4. The system of claim 2, further comprising a microcontroller that generates at least one duty cycle modulation signal based on user input.

5. A system, comprising:
at least one power supply for the control circuitry, and
two or more channels of the following:
at least one rectification component,
at least one series DC current switch,
at least one duty cycle modulation unit,
at least one means for a user to input desired intensity level,
at least one LED light source attached directly or through a rectifier component to AC line voltage, and
at least one passive current limiting element in series with the LED light source.

6. The system of claim 5, further comprising a module that adjusts the user input to compensate for characteristics of the human eye and/or light source.

7. The system of claim 5, further comprising a microcontroller that generates at least two duty cycle modulation signals based on user input.

8. The system of claim 6, further comprising a microcontroller that generates at least two duty cycle modulation signals based on user input.
